(19) United States
(12) Patent Application Publication
(10) Pub. No.: US 2014/0176081 A1
(43) Pub. Date: Jun. 26, 2014

(54) BOOST CONTROL METHOD AND SYSTEM FOR BOOST CONVERTER

(71) Applicant: HYUNDAI MOTOR COMPANY, Seoul (KR)

(72) Inventors: Boung Ho Min, Yongin (KR); Jae Moon Lee, Suwon (KR); Ho Sung Kang, Seoul (KR); Ji Tae Kim, Yongin (KR)

(21) Appl. No.: 13/942,886

(22) Filed: Jul. 16, 2013

(30) Foreign Application Priority Data
Dec. 24, 2012 (KR) 10-2012-0152413

(51) Int. Cl. H02J 7/00

(52) U.S. Cl. CPC H02J 7/0065
USPC 320/136

(57) ABSTRACT

A boost control method and system for a boost converter by which a stability of parts is secured when a fuel cell vehicle is started up, and the number of parts is reduced by eliminating an additional hardware construction such as a pre-charge relay. The boost control method includes analyzing a battery state before a boost, and determining a normal state and when the battery state is normal, a processor executes a first boost mode via the boost converter to primarily boost up a voltage of a bus terminal. In addition, the method includes analyzing situation data during the primary boost, and determining an abnormal state of the bus terminal and when the bus terminal is normal, the processor executes a second boost mode to increase a voltage of the bus terminal up to a final target value.

### CROSS-REFERENCE TO RELATED APPLICATION

This application claims under 35 U.S.C. §119(a) the benefit of Korean Patent Application No. 10-2012-0152413 filed Dec. 24, 2012, the entire contents of which are incorporated herein by reference.

### BACKGROUND

(a) Technical Field

The present invention relates to a boost control method and system for a boost converter by which a stability of parts can be secured when a fuel cell vehicle is started up, and the number of parts can be reduced by eliminating an additional hardware construction such as a pre-charge relay.

(b) Background Art

In recent years, a fuel cell vehicle includes a fuel cell stack that generates electrical energy, a fuel supply system that supplies a fuel (e.g., hydrogen) to the fuel cell stack, an air supply system that supplies oxygen in air which is an oxidizer necessary for an electrochemical reaction to the fuel supply stack, and a heat/water management system that controls an operation temperature of the fuel cell stack.

Each system of the fuel cell vehicle includes parts driven by a high voltage (e.g., 50 V or higher). For example, the air supply system includes an air blower and the heat/water management system includes a water pump. Since the high-voltage driven parts (e.g., the air blower, the water pump, and the like) cannot be directly driven by a 12 V battery power source, the parts are started up by an electric power boosted up in the 12V battery and then operated by an electric power generated in a stack. Thus, a DC-DC (direct current) converter is necessary as an apparatus to boost up the 12V battery and generate a high voltage to drive the high-voltage driven part when the fuel cell battery is started up. To start up the fuel battery vehicle, after a bus terminal voltage is boosted up using a battery voltage (e.g., a high voltage or a low voltage) of the vehicle through a boost converter, an air blower is driven by the boosted voltage of the bus terminal and air and hydrogen are supplied to the stack to start up the air blower.

Since the voltage boost of the bus terminal through the boost converter is initially performed when the vehicle is started, an abnormal state (e.g., a breakdown of a wire, a short-circuit, a damage to a part, and the like) is determined, the voltage should be boosted up in a normal state (e.g., when no breakdown of a wire, a short-circuit, damage to a part, or the like occurs) and should not be boosted up in an abnormal state. Examples of using a low-voltage battery (e.g., lower than 50 V, a general vehicle battery) and using a high-voltage battery (e.g., 50 V or higher) to start up the fuel battery vehicle will be described below.

FIG. 2 is an exemplary view showing a start-up method of a fuel battery vehicle using a low-voltage battery according to the related art. A boost converter (e.g., DC-DC converter) 3 receives a voltage from a low-voltage battery 2 connected to an input side and boosts up a battery voltage up to 300 V to 450 V and a bus terminal 5 is connected to an output side of the boost converter 3 to receive the boosted voltage of 300 V to 450 V and apply the boosted voltage to the air blower 4 connected to the bus terminal 5, to allow the air blower 4 to be driven to start up the fuel cell stack 1. The low-voltage battery 2 is a general vehicle battery and is connected to the boost converter 3 to boost up a battery voltage without using a hardware construction such as a pre-charge relay. However, when a problem occurs in the bus terminal 5, the boost converter 3 may be permanently damaged when the battery voltage is boosted up.

FIG. 3 is an exemplary view showing a start-up method using a high-voltage battery according to the related art. Since the bus terminal 5 may be damaged due to a voltage difference between a high voltage and an initial voltage (0 V) of the bus terminal 5 when a high voltage is abruptly applied, a pre-charge relay 15 is connected between the bus terminal 5 and the high-voltage battery 12 to primarily boost up a voltage of the bus terminal to a battery voltage, boost up the voltage of the bus terminal 5 up to 300 V to 450 V, and drive the air blower 4 to start up the fuel battery stack 1.

Then, an abnormal state of the bus terminal 5 can be determined by connecting the pre-charge relay 15 and identifying a current, a voltage, and a time until the primary boost, and an additional boost is performed using the boost converter 13 when the bus terminal 5 is normal and an additional boost is not performed when the bus terminal 5 is abnormal. However, when hardware such as the pre-charge relay 15 is additionally used, manufacturing costs increase due to an increase in the number of parts and a danger factor such as a breakdown of a relay increases.

### SUMMARY

The present invention provides a boost control method and system for a boost converter in which a safety of a part may be secured when a fuel cell vehicle is started up, by allowing a boost converter to detect a pre-charging function in a software algorithm method without using an additional hardware construction, the number of parts may decrease, manufacturing costs may decrease, and a latent breakdown probability may decrease.

In accordance with an aspect of the present invention, a boost control method of a booster converter, may include: analyzing a battery state before a boost, and determining a normal state; when the battery state is normal (e.g., no malfunction has occurred), progressing a first boost mode through the boost converter to primarily boost up a voltage of a bus terminal; analyzing situation data during the primary boost, and determining an abnormal state of the bus terminal, wherein the voltage of the bus terminal may be increased; and when the bus terminal is normal, progressing a second boost mode to increase a voltage of the bus terminal up to a final target value, wherein a pre-charging function of the boost converter is executed by a software algorithm method without using an additional hardware construction to start up a fuel battery.

In one embodiment of the present invention, the primary boost may be performed by V_{B}+(V_{T}−V_{B})×(0.1˜0.2) where V_{B} is a voltage before a boost and V_{T} is a target boost voltage.

In another embodiment of the present invention, an abnormal state of the bus terminal may be determined by analyzing an amount of current flowing through the bus terminal during the primary boost, reaching of a target voltage during the primary boost, and a primary boost time. In addition, when the battery state is normal in determining of an abnormal state of the battery before the boost, the vehicle may be restarted.

In a further embodiment of the present invention, when any one of the three conditions is not satisfied in the determining of an abnormal state of the bus terminal, the boost of the bus terminal may be stopped and the vehicle may be restarted.

The advantages of a boost control method and system of a boost converter according to the present invention are as follows.

First, according to the present invention, by executing a pre-charging function in an algorithm method in a boost converter when the fuel cell vehicle is started up using a boost of the bus terminal, a second boost may not be performed when bus terminal is determined to be abnormal after an abnormal state of the bus terminal is determined during a primary boost when the fuel cell vehicle is started up using a low-voltage battery, thereby preventing a permanent damage to the boost converter without using an additional hardware construction.

Second, when the fuel cell battery is started up using a high-voltage battery, manufacturing costs may be reduced, the number of parts may decrease, and a breakdown danger factor may decrease due to elimination of a hardware pre-charge relay.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary flowchart showing a boost control method of a boost converter according to an exemplary embodiment of the present invention;

FIG. 2 is an exemplary view showing a start-up method of a fuel cell vehicle using a low-voltage battery according to the related art; and

FIG. 3 is an exemplary view showing a start-up method of a fuel cell vehicle using a high-voltage battery according to the related art.

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, an exemplary embodiment of the present invention will be described in detail with reference to the accompanying drawings so that those skilled in the art to which the present invention pertains can easily carry out the invention.

The present invention relates to a boost control method and system of a boost converter that allows a boost converter to execute a pre-charging function in a software algorithm method without using an additional hardware construction.

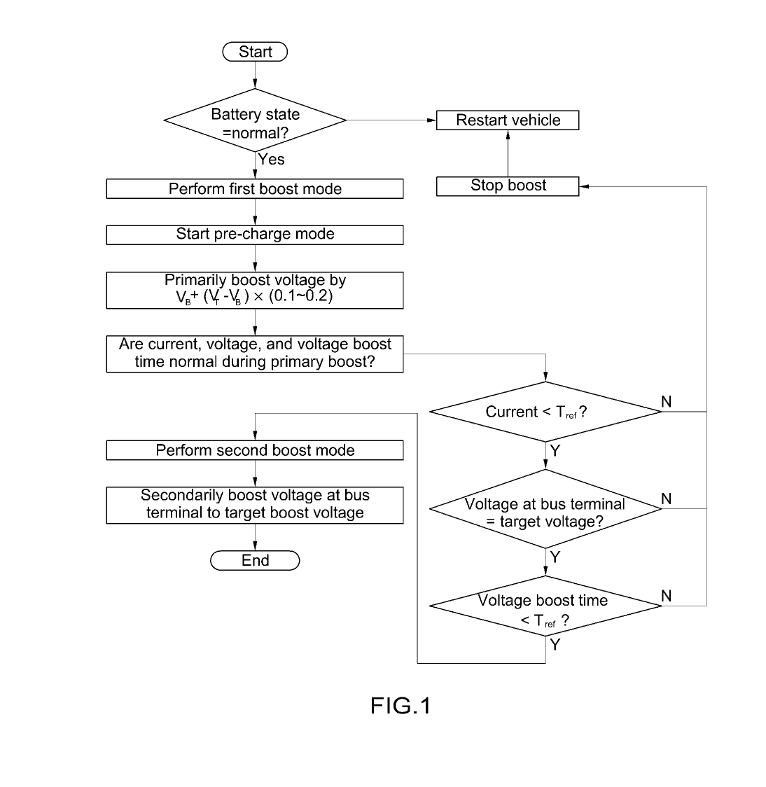

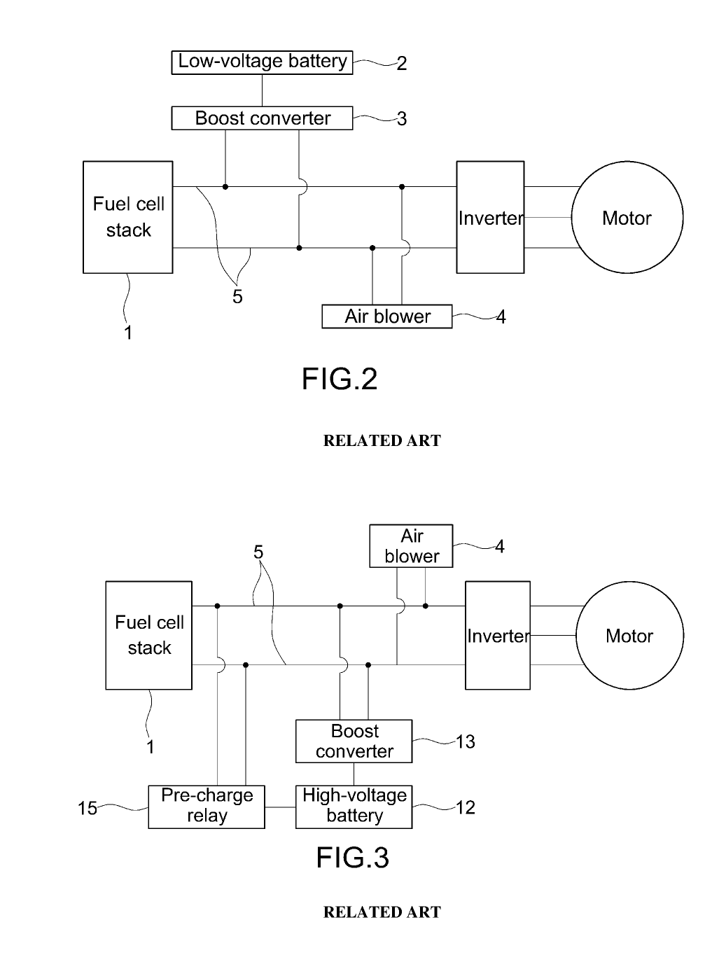

FIG. 1 is an exemplary flowchart of a boost control method of a boost converter according to an exemplary embodiment of the present invention. As shown in FIG. 1, before a boost is analyzed, whether the battery state is normal (e.g., no malfunctions have occurred as of that moment in time) may be determined. When the battery state is determined to be under normal operation, the boost converter may execute, by a processor on a controller, a first boost mode, and when the battery state is determined to be under abnormal operation, the vehicle may be restarted.

Specifically, in the first boost mode, the voltage may be primarily boosted by a predetermined voltage via the boost converter in a pre-charge mode. In particular, the predetermined voltage may be set to, for example, V_{B}+(V_{T}−V_{B})×(0.1˜0.2), where V_{B} is a battery voltage before a boost and V_{T} is a target boost voltage.

Moreover, an abnormal state of a bus terminal may be determined by analyzing situation data during the primary boost. The abnormal state of the bus terminal may be determined by analyzing, by the controller, an amount of current flowing during the primary boost, a target voltage reached during the primary boost, and a primary boost time. For example, whether an amount of current is smaller than a reference current value I_{ref,,} whether the voltage reaches a primary target voltage during the primary boost, and whether the primary boost time is smaller than a reference boost time T_{ref.} may be determined Then, the reference current value and the reference boost time may be set to effective values in each system. For example, the reference current values may be 5 A, 10 A, and 15 A, and the reference boost times may be 100 ms, 200 ms, and 500 ms.

Furthermore, when all the three conditions are satisfied, the bus terminal may be determined to be operating as normal and the boost converter may execute, by the processor, the second boost mode, and when any one of the three conditions is not satisfied, the bus terminal may be determined to be operating as abnormal, the boost may be stopped, and the vehicle may be restarted.

In the second boost mode, after the voltage of the bus terminal is boosted to the final target value, air and hydrogen may be supplied to a stack to start up the stack as an air blower is driven using the boosted voltage of the bus terminal.

According to the related art, when a fuel cell vehicle is started up using a high-voltage battery, for example, the fuel cell is started up by boosting a voltage of a bus terminal from 0 V to 180 V using an additional hardware construction such as a pre-charge relay and secondarily boosting the voltage from 180 V to 400 V using a boost converter, whereas according to the present invention, both the primary boost and the secondary boost may be performed using a boost converter without using an additional hardware construction.

Thus, according to the present invention, by executing a pre-charging function in an algorithm method in a boost converter when the fuel cell vehicle is started up using a boost of the bus terminal, a second boost may not be performed when the bus terminal is determined to be abnormal after the abnormal state of the bus terminal is determined during a primary boost when the fuel cell vehicle is started up using a low-voltage battery, thus, preventing a permanent damage to the boost converter without using an additional hardware construction.

Further, when the fuel cell battery is started up using a high-voltage battery, manufacturing costs may be reduced, the number of parts may decrease, and a breakdown danger factor may decrease due to elimination of a hardware pre-charge relay.

The invention has been described in detail with reference to exemplary embodiments thereof. However, it will be appreciated by those skilled in the art that changes may be made in these embodiments without departing from the principles and spirit of the invention, the scope of which is defined in the accompanying claims and their equivalents.

What is claimed is:

1. A boost control method of a booster converter, comprising:
analyzing, by a processor, a battery state before a boost, and determining a normal state;
when the battery state is determined to be normal, executing, by the processor, a first boost mode via the boost converter to primarily boost up a voltage of a bus terminal;
analyzing, by the processor, situation data during the primary boost, and determining an abnormal state of the bus terminal; and
when the bus terminal is normal, executing, by the processor, a second boost mode to increase a voltage of the bus terminal up to a final target value.

2. The boost control method of claim 1, wherein the primary boost is performed by V_{B}+(V_{T}−V_{B})×(0.1˜0.2) where V_{B} is a voltage before a boost and V_{T} is a target boost voltage.

3. The boost control method of claim 1, wherein an abnormal state of the bus terminal is determined by analyzing an amount of current flowing through the bus terminal during the primary boost, a target voltage during the primary boost, and a primary boost time.

4. The boost control method of claim 1, wherein when the battery state is normal in determining of an abnormal state of the battery before the boost, the vehicle is restarted.

5. The boost control method of claim 3, wherein when any one of the three conditions is not satisfied in the determining of an abnormal state of the bus terminal, the boost of the bus terminal is stopped and the vehicle is restarted.

6. A system that controls boost, comprising:
a processor configured to:
analyze a battery state before a boost, and determining a normal state;
execute a first boost mode via the boost converter to primarily boost up a voltage of a bus terminal, when the battery state is determined to be normal;
analyze situation data during the primary boost, and determining an abnormal state of the bus terminal; and
execute a second boost mode to increase a voltage of the bus terminal up to a final target value, when the bus terminal is normal.

7. The system of claim 6, wherein the primary boost is performed by V_{B}+(V_{T}−V_{B})×(0.1˜0.2) where V_{B} is a voltage before a boost and V_{T} is a target boost voltage.

8. The system of claim 6, wherein the processor is further configured to:
determine an abnormal state of the bus terminal by analyzing an amount of current flowing through the bus terminal during the primary boost, a target voltage during the primary boost, and a primary boost time.

9. The system of claim 6, wherein when the battery state is normal in determining of an abnormal state of the battery before the boost, the vehicle is restarted.

10. The system of claim 8, wherein when any one of the three conditions is not satisfied in the determining of an abnormal state of the bus terminal, the boost of the bus terminal is stopped and the vehicle is restarted.

11. A non-transitory computer readable medium containing program instructions executed by a processor or controller, the computer readable medium comprising:
program instructions that analyze a battery state before a boost, and determining a normal state;
program instructions that execute a first boost mode via the boost converter to primarily boost up a voltage of a bus terminal, when the battery state is determined to be normal;
program instructions that analyze situation data during the primary boost, and determining an abnormal state of the bus terminal; and
program instructions that execute a second boost mode to increase a voltage of the bus terminal up to a final target value, when the bus terminal is normal.

12. The non-transitory computer readable medium of claim 10, wherein the primary boost is performed by V_{B}+(V_{T}−V_{B})×(0.1˜0.2) where V_{B} is a voltage before a boost and V_{T} is a target boost voltage.

13. The non-transitory computer readable medium of claim 10, further comprising:
program instructions that determine an abnormal state of the bus terminal by analyzing an amount of current flowing through the bus terminal during the primary boost, a target voltage during the primary boost, and a primary boost time.

14. The non-transitory computer readable medium of claim 10, wherein when the battery state is normal in determining of an abnormal state of the battery before the boost, the vehicle is restarted.

15. The non-transitory computer readable medium of claim 13, wherein when any one of the three conditions is not satisfied in the determining of an abnormal state of the bus terminal, the boost of the bus terminal is stopped and the vehicle is restarted.
